(19) United States
(12) Patent Application Publication
(10) Pub. No.: US 2011/0125512 A1
(43) Pub. Date: May 26, 2011

(54) SYSTEMS AND METHODS FOR PROVIDING DIGITAL PUBLICATIONS

(75) Inventor: Ken Cheng Kai Huang, Vancouver (CA)

(73) Assignee: Magme Media Inc., Vancouver (CA)

(21) Appl. No.: 12/954,432

(22) Filed: Nov. 24, 2010

Related U.S. Application Data
(60) Provisional application No. 61/264,003, filed on Nov. 24, 2009.

(51) Int. Cl. G06Q 30/00

(52) U.S. Cl. 705/1.1

(57) ABSTRACT

A digital publication platform has a publication server for providing a digital publication to a reader through a reader interface. The publication server monitors and records the reader's instructions to the reader interface. The instructions provide reader activity data. The platform has a publication creation and management subsystem in communication with the publication server. The subsystem is configured to obtain a digital publication, receive requests and payment for creation of interactive elements in the digital publication from a user, create interactive elements within the digital publication, provide the digital publication to the publication server, receive the reader activity data from the publication server, and determine an amount for payment for the interactive elements from the user based on the reader activity data.

### REFERENCE TO RELATED APPLICATION

This application claims priority from U.S. Provisional Patent Application No. 61/264,003 filed 24 Nov. 2009 entitled “SYSTEMS AND METHODS FOR PROVIDING DIGITAL PUBLICATIONS.” This application claims the benefit of U.S. Provisional Patent Application No. 61/264,003 filed 24 Nov. 2009 entitled “SYSTEMS AND METHODS FOR PROVIDING DIGITAL PUBLICATIONS” under 35 USC §119.

### TECHNICAL FIELD

This invention relates to systems and methods for providing digital publications. Particular embodiments provide systems and methods for creating and editing dynamic content for digital publications and for tracking reader activity.

### BACKGROUND

Print media such as magazines, journals, newspapers, catalogues, brochures, flyers, books or the like may be provided in the form of digital publications displayed on the screen of a computer, mobile handheld device, television, digital book reader or the like. Digital publications may be displayed as a series of pages in single or double page spread, each page having text and images arranged in an attractive layout similar to a paper publication. A reader uses an input device such as a mouse, touch screen display, or keyboard to mimic the act of turning the pages of the paper publication so as to navigate through the digital publication.

The content (text and images) of digital publications are typically static in nature, similar to paper publications (i.e. a reader may view only the pages, as is). If a publisher wishes to provide a digital publication with hyperlinks, audio or video content, the publisher may enlist the assistance of a web programmer to write code to create a digital publication providing such content. Therefore, it may take some time to generate the digital publication with the requested content. Moreover, hiring a programmer may be prohibitively expensive for many publishers, or the costs may be passed on to online readers in higher subscription costs and/or to advertisers in higher advertising costs, thereby making it difficult to attract online readers and/or advertisers.

There is a general desire for systems and methods to enable publishers and other users to create and edit digital publications which include dynamic content. There is a general desire for systems and methods to track reader activity and interaction with dynamic content in digital publications.

### SUMMARY

This invention has a wide range of aspects. One aspect of the invention provides a digital publication platform for providing a digital publication to a reader. The digital publication may be viewed on a reader device by the reader. The platform includes a publication server for providing a digital publication to the reader device through a reader interface. The publication server has a tracker for monitoring and recording the reader's instructions to the reader interface. Reader activity data may comprise or be derived from the reader's instructions. The platform has a repository for storing the reader activity data.

The platform includes a publication creation and management subsystem in communication with the publication server and the repository. The subsystem is configured to receive a print publication in soft copy form from a user, convert the print publication to a digital publication, receive a request for creation of an interactive element in the digital publication from the user, receive and confirm payment information for payment of the interactive element from the user, create the interactive element within the digital publication, provide the digital publication to the publication server, receive the reader activity data from the publication server, and determine an amount for payment for the interactive element from the user based at least in part on the reader activity data.

In addition to the exemplary aspects and embodiments described above, further aspects and embodiments will become apparent by reference to the drawings and by study of the following detailed descriptions.

### BRIEF DESCRIPTION OF DRAWINGS

Exemplary embodiments are illustrated in referenced figures of the drawings. It is intended that the embodiments and figures disclosed herein are to be considered illustrative rather than restrictive.

FIG. 1 is a data flow diagram depicting the interactions between external agents and a system according to one embodiment.

FIG. 2 is a data flow diagram depicting data that may be tracked by a digital publication platform according to one embodiment which may be used in the FIG. 1 system.

FIG. 3 is a data flow diagram depicting the flow of data through a specific implementation of the FIG. 1 system.

FIG. 4 schematically depicts the components of a publication editor according to one embodiment which may be used in the FIG. 5 digital publication platform.

FIG. 5 schematically depicts the components of a digital publication platform according to one embodiment which may be used in the FIG. 1 system.

FIG. 6 is a flowchart illustrating a method for creating a digital publication according to one embodiment.

FIG. 7 is a flowchart illustrating a method for creating an interactive element according to one embodiment.

### DESCRIPTION

Throughout the following description, specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

Interactive elements or links may be placed in a digital publication to provide dynamic content to the reader beyond that which is displayed on the static print publication pages. A display device may display the digital publication in the form of one or more pages. A visual indicator of each interactive element may be displayed on a page to invite the readers of the publication to engage with the interactive element. Readers may activate the interactive elements to access the dynamic content. Such interaction may include one of the following events or a combination thereof:
the reader moving a cursor to a particular area on the page or particular text, buttons, images, etc.;
the reader clicking a mouse or other input device while the cursor is at a particular area on the page or on particular text, buttons, images, etc.;
the reader entering text into an input field;
and the like.

When an interactive element is activated, dynamic content is provided, such as, for example:
linking, or turning, to another page within the same publication;
linking to a website, which may be opened in a new browser window or tab;
displaying text and/or images, or playing a video or audio file (e.g. providing further information about products or services featured in an advertisement or article within the publication), within the digital publication reader interface window (e.g. using an on-page solution), in a new browser window or tab, or pop-up window;
launching an e-commerce site within the digital publication reader interface window (e.g. using an on-page solution), in a new browser window or tab, or pop-up window;
and the like.

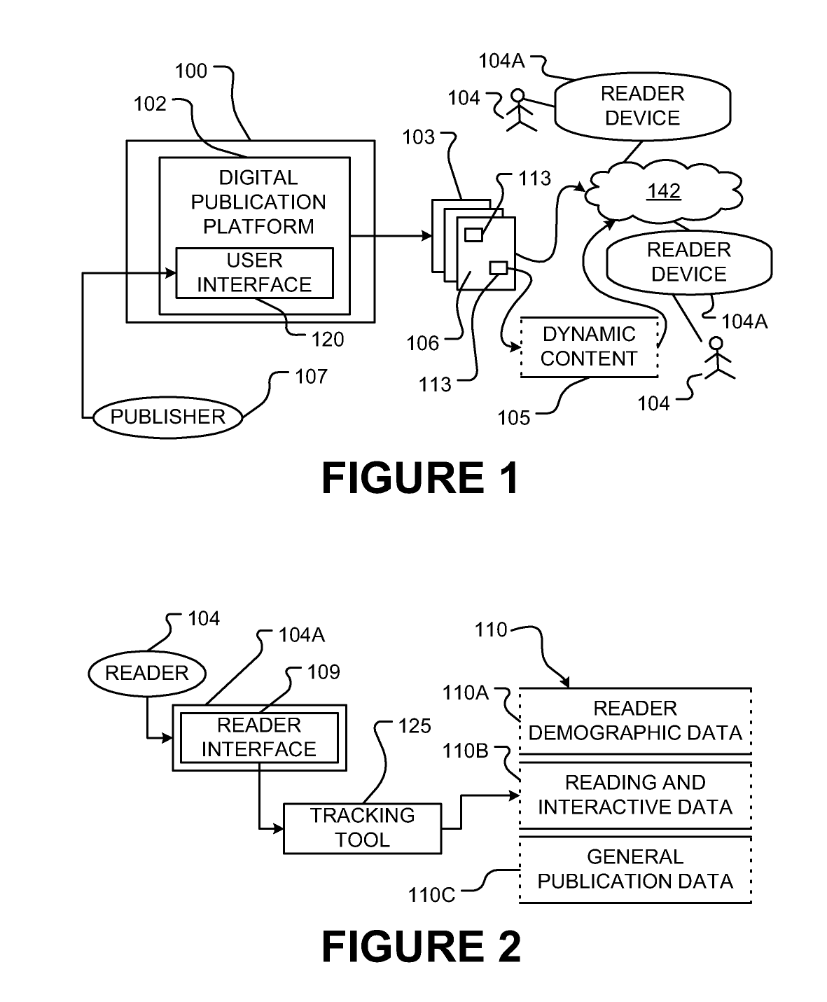

According to embodiments described herein, systems and methods are provided for enabling publishers or other users to create and edit digital publications providing dynamic content. FIG. 1 shows a system 100 according to a particular embodiment. System 100 includes a digital publication platform 102 configured to create a digital publication 103 which is provided or distributed to readers 104. Each reader 104 views digital publication 103 on a reader device 104A connected to a network 142 (e.g. the Internet). Digital publication 103 may include one or more transparent layers or overlays 106 with interactive elements 113 which may be activated to provide dynamic content 105 to readers 104. Digital publication 103 may be generated in the form of a web application using suitable multimedia, programming and/or scripting tools or languages such as: Flash, Java, FlashPaper, Javascript, Java FX, Google Web Toolkit (GWT), Ajax, Silverlight, XML, HTML version 5 (or older), and the like.

In the FIG. 1 embodiment, digital publication platform 102 provides a digital publication user interface 120 which interfaces with applications (not shown) of the digital publication platform 102 to generate digital publications 103. User interface 120 enables publishers 107 to create and edit digital publications 103 including interactive elements 113, without requiring publishers 107 to write code for a digital publication web application.

According to particular embodiments, the publisher and the provider of digital publication platform 102 (the “platform provider”) may agree that the publisher and/or the platform provider will collect fees from advertisers or other entities which have requested content to be placed in digital publication 103 (including, for example, interactive elements 113 for providing dynamic content). The publisher and the platform provider may agree on how to apportion such fees between themselves. The publisher and platform provider may also agree that the fees are calculated based at least in part on reader activity. As such, particular embodiments of digital publication platform 102 provide tools to track and collect reader activity data for digital publication 103. Such data may be based on reader instructions received at the digital publication platform 102 (e.g. at a digital publication server 140) from a reader interface 109 associated with the reader.

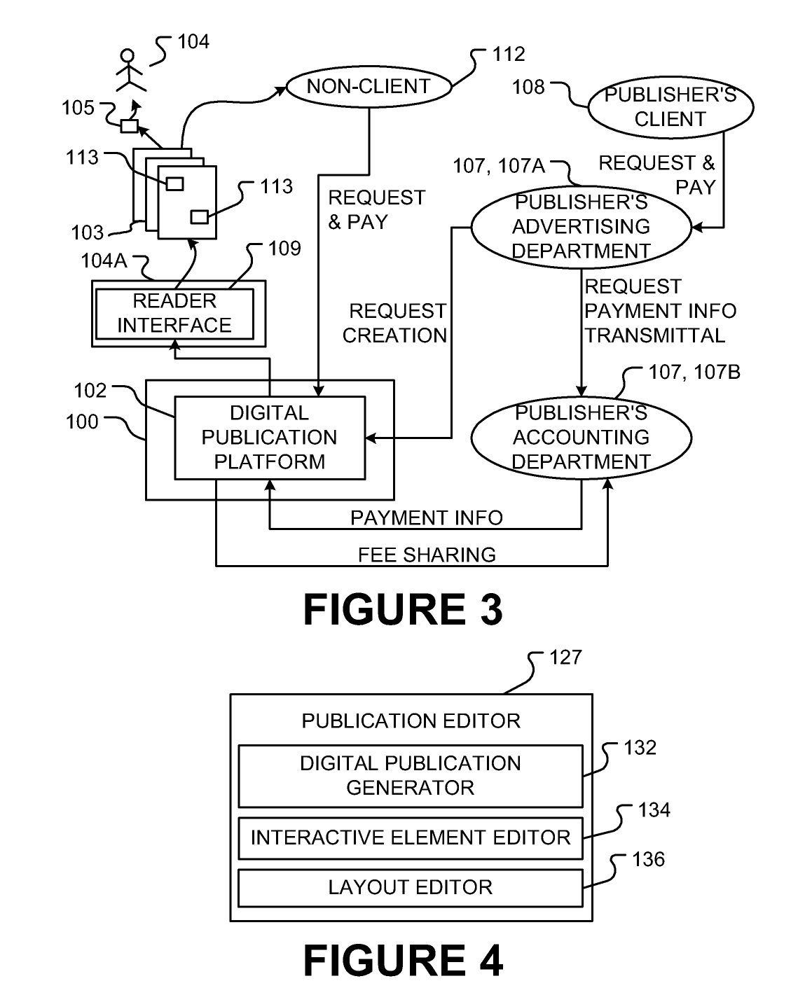

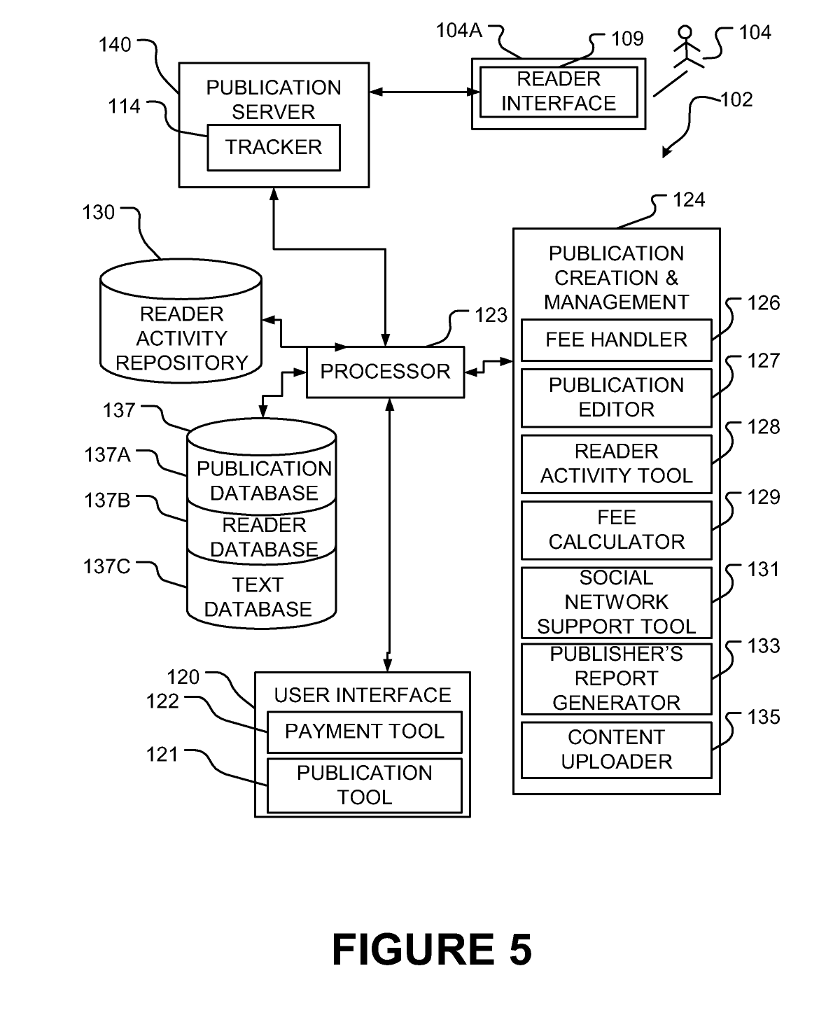

FIG. 2 illustrates reader activity which may be tracked by a tracking tool provided by a digital publication platform such as the FIG. 1 digital publication platform 102. Digital publication platform 102 provides a reader interface 109 (FIG. 3) which may be accessed by a reader 104 using a reader device 104A such as provided by the reader's computer, mobile handheld device or the like. Reader interface 109 receives instructions or input from reader 104. Such instructions may include instructions to view and navigate through digital publication 103 and interact with interactive elements 113 therein. Instructions provided by reader 104 to reader interface 109 may be monitored, recorded (and processed) by tracking tool 125 to provide reader activity data 110. Reader activity data 110 may be stored in a suitable storage medium (e.g. as a part of system 100) for subsequent retrieval and analysis. In particular embodiments, reader activity data 110 is communicated (e.g. via network 142) to a digital publication server 140 for storage in a reader activity repository 130 (see FIG. 5). Reader activity data 110 may comprise a reader 104's instructions and/or may include other information concerning the reader 104's reading patterns which are derived from reader 104's instructions as reader 104 interacts with reader interface 109.

As shown in FIG. 2, reader activity data 110 may include one or more of the following:
Reader demographic data 110A comprising information about the general characteristics of readers 104. Reader demographic data 110A may be provided directly by the reader (e.g. readers 104 may complete a form or questionnaire to register for an account to read digital publication 103) or indirectly (e.g. by detecting an IP and/or MAC address associated with reader device 104A and other such information).
Reading and interactive data 110B comprising information about how readers 104 are reading and engaging with digital publication 103. This may include data relating to the extent to which readers 104 are engaging with and activating interactive elements 113 (e.g. by detecting which interactive elements 113 are activated and monitoring the time between reader activation of interactive elements 113 and monitoring the number of times that a particular interactive element 113 is activated), and the duration that readers 104 spend viewing digital publication 103, particular pages thereof or dynamic content 105.
General publication data 110C comprising information such as the number of subscriptions to digital publication 103, the geographical area(s) over which digital publication 103 is distributed, the number of readers 104 reading a digital publication 103 at any given time, and trends in such data over a period of time.

FIG. 3 illustrates the flow of data through a specific implementation of the system 100 shown in FIG. 1. As seen in FIG. 3, a publisher 107's advertising department 107A receives a request and payment from publisher 107's client 108 to place one or more interactive elements 113 in a digital publication 103. Such interactive elements 113, when activated by a reader 104, provide dynamic content 105 (e.g. in the form of text, images, video, audio, e-commerce options, links to other websites, etc.). Advertising department 107A sends a request to digital publication platform 102 to create a digital publication 103 including interactive elements 113.

In the illustrated embodiment, publisher 107's advertising department 107A sends a request to publisher 107's accounting department 107B to transmit payment information (e.g. credit card or deposit account authorization, etc.) to the digital publication platform 102 to pay for interactive elements 113. Upon receiving the request from advertising department 107A and payment information from accounting department 107B, digital publication platform 102 generates digital publication 103 including the requested interactive elements 113, and provides digital publication 103 to reader device 104A by way of reader interface 109. Readers 104 may then input instructions to reader device 104A via reader interface 109 to activate interactive elements 113 to access dynamic content 105 associated with interactive elements 113.

Upon reading digital publication 103, a business or other entity 112 which is not one of the publisher 107's clients 108 may become interested in placing an interactive element 113 in digital publication 103 to advertise its products or services. For example, business 112 may determine that it would be advantageous to place an interactive element 113 to provide information about its products or services on a particular page of digital publication 103 featuring an article on a topic which may be of particular interest to business 112's customers or clients. In the FIG. 3 embodiment, business 112 may send a request and payment information to digital publication platform 102 for the placement of one or more interactive elements 113 in digital publication 103. Upon receiving such request and payment information, digital publication platform 102 adds interactive elements 113 to digital publication 103. According to particular embodiments, advertising fees are apportioned between the publisher 107 and the provider of digital publication platform 102. As shown in FIG. 3, a portion of the fees collected from businesses 112 for placement of interactive elements 113 may be given to publisher 107 through publisher 107's accounting department 107B.

In some embodiments, prior to adding a particular interactive element 113 to digital publication 103 at the request of a business 112, business 112's request may be compared to one or more criteria to determine whether interactive element 113 may be added. For example, such criteria may comprise: a list of businesses that are not permitted to advertise in a particular digital publication 103 or portion of such publication; or a list of types of products and/or services that may not be featured in a particular digital publication 103 or portion of such publication.

Business 112 may interact with digital publication platform 102 in a similar manner as publisher 107, including making requests for placement of interactive elements 113 and providing payment information. While the FIG. 5 embodiment, described below, is described with reference to input from a publisher 107, it is to be understood that in the embodiments described herein, input from a business 112 may also be provided to digital publication platform 102 in a similar manner.

FIG. 5 illustrates the components of a digital publication platform 102 that may be used in system 100 shown in FIG. 1. Digital publication platform 102 of the FIG. 5 embodiment includes a digital publication user interface 120 which receives input from publisher 107 (or business 112). In the illustrated embodiment, user interface 120 has a publication tool 121 which accepts input regarding the generation of digital publications 103 and interactive elements 113 from publisher 107 (e.g. publisher 107's advertising department 107A). User interface 120 also has a payment tool 122 which accepts payment information from publisher 107 (e.g. publisher 107's accounting department 107B). Digital publication platform 102 includes a processor 123 which calls and executes applications from a set of publication creation and management applications 124 on the basis of input received at user interface 120. User interface 120 may be implemented, in whole or in part, as software executed by, and contained in a program memory accessible to, processor 123. User interface 120 may also comprise suitable interface hardware, which may be under the control of processor 123.

In the FIG. 5 embodiment, digital publication platform 102 includes a publication server 140 in communication with processor 123. (In other embodiments, publication server 140 may be provided on another platform which is external to, but accessible by, digital publication platform 102, such as a server of a web hosting provider.) Publication server 140 provides digital publication 103 to reader devices 104A connected to a network 142. A reader activity tracker 114 may be implemented as software on publication server 140 to monitor instructions provided by readers 104 by way of reader interface 109 associated with each reader device 104A; such instructions are received at publication server 140. Data regarding readers' instructions may then be sent by tracker 114 to processor 123 for processing (e.g. by reader activity tool 128) and storage in reader activity repository 130.

As seen in FIG. 5, publication creation and management applications 124 may include:
fee handler 126 for processing payment information from publisher 107;
publication editor 127 for generating and editing a digital publication 103 including interactive elements 113 based on input received at user interface 120;
reader activity tool 128 for processing readers' instructions received at publication server 140 to provide reader activity data 110 (FIG. 2);
fee calculator 129 for determining the fees charged to publisher 107 and/or publisher 107's clients 108 based at least in part on the reader activity data 110;
social network support tool 131 for providing content to and from social networking sites;
publisher's report generator 133 for generating reports on reader activity; and
content uploader 135 for adding new content to digital publication 103. Each of the above applications may be implemented, in whole or in part, as software, executed by, and contained in a program memory accessible to, processor 123.

Fee calculator 129 may determine fees charged to publisher 107 and/or publisher 107's clients 108 using an algorithm which may take into account one or more of the following, for example:
the number of clicks (e.g. measured in units of 1000's of clicks) to a particular interactive element 113 over a given time period (e.g. such time period may be a current time period, a historical time period, or a combination thereof);
the frequency of activation of interactive elements 113 over a given time period;
the number of subscribers to a digital publication 103; and/or
the like.
   Such information may be provided by or derived from reader activity data 110. Reader activity data 110 may be obtained from publication server 140 and/or reader activity repository 130 (FIG. 5).

FIG. 4 shows a publication editor 127 according to a particular embodiment. As seen in FIG. 4, publication editor 127 may include components or functions such as:
digital publication generator 132 which generates pages for a digital publication 103 based on a print publication soft copy;
interactive element editor 134 which inserts interactive elements 113 in digital publication 103; and
layout editor 136 for editing the layout of digital publication 103 and customizing the publication reader interface.

In the illustrated embodiment of FIG. 5, digital publication platform 102 includes a repository 137 for storing data related to digital publication 103. Repository 137 is in communication with processor 123 and may include various databases such as a publication database 137A for storing the digital publication files (e.g. Flash files; image files, etc.) and a reader database 137B for storing information about readers 104 of digital publication 103 (e.g. account information, reader preferences, etc.). Repository 137 may also include a searchable text-based database 137C of content in digital publication 103 (including publication articles, dynamic content, etc.). Database 137C enables readers 104 and publishers 107 to conduct text-based searches through the digital publications to locate content of interest.

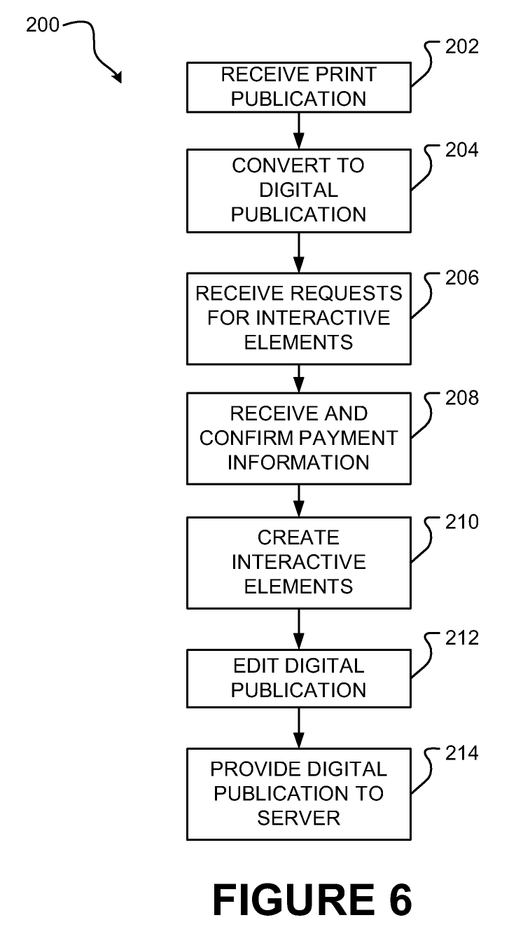

FIG. 6 shows a method 200 for creating a digital publication 103 according to one embodiment. Method 200 may be implemented by processor 123 (FIG. 5) executing suitable software instructions. Such software instructions may be provided by one or more components of publication editor 127 (FIGS. 4 and 5). Method 200 begins at block 202 by receiving a print publication in soft copy form. Method 200 proceeds to block 204, where the soft copy print publication is converted to a digital publication (e.g. by applying digital publication generator 132 of FIG. 4). At block 206, requests for placement of interactive elements 113 in digital publication 103 are received. Such requests may originate from a publisher or user 107 in response to advertising orders from one of publisher 107's clients 108, or from a business 112 which is not one of publisher 107's clients 108 (as seen in FIG. 3). Method 200 proceeds to block 208, at which payment information for the block 206 requests is received and confirmed (e.g. so that payment will be received from publisher 107 or businesses 112 for placement of interactive elements 113).

Once payment has been confirmed, method 200 proceeds to block 210, at which interactive elements 113 are created in accordance with the block 206 requests and are placed within digital publication 103 (e.g. by applying interactive element editor 134 of FIG. 4). At block 212, digital publication 103 may be edited (e.g. by applying layout editor 136 of FIG. 4). For example, the layout of text, images and/or interactive elements 113 in digital publication 103 may be modified. At block 214 a copy of the completed digital publication 103 is provided to publication server 140 (FIG. 5) for distribution to readers 104 via their associated reader devices 104A.

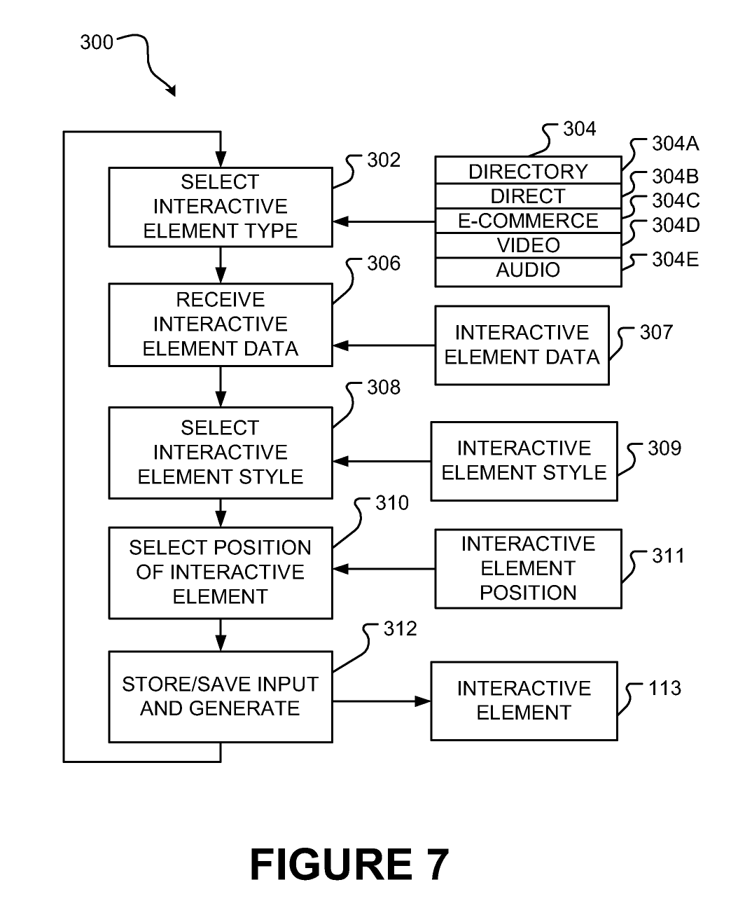

FIG. 7 shows a method 300 for creating an interactive element 113. Method 300 may be performed at block 210 in method 200 of FIG. 6. Method 300 may be implemented by a processor 123 (FIG. 5) executing suitable software instructions, in response to input from a user (i.e. the user may interact with user interface 120 of FIG. 5). Such software instructions may be provided by one or more components of publication editor 127 (FIGS. 4 and 5). Method 300 begins at block 302 by selecting for interactive element 113 (e.g. in response to user input) an interactive element type 304 from a list of available types. For example, interactive element type 304 may be: a directory type 304A for linking to a location within the digital publication, a direct type 304B for linking to a website; an e-commerce type 304C for launching an e-commerce transaction; a video type 304D for linking to and playing a video file; an audio type 304E for linking to and playing an audio file; or the like.

Method 300 proceeds to block 306 at which the user is prompted to enter interactive element data 307 for the interactive element type 304 selected at block 302. Interactive element data 307 may specify the Uniform Resource Locator (URL) (or some other form of pointer associated with interactive element 113) associated with the direct link, e-commerce site, video, audio, etc. If dynamic content 105 is to be provided as an on-page solution, interactive element data 307 may include the file providing the video, audio, image, etc.

At block 308 an interactive element style 309 is selected for interactive element 113. Interactive element style 309 may determine attributes of interactive element 113 such as how interactive element 113 is activated by the reader (e.g. by clicking or moving the cursor, etc.), how dynamic content 105 is to be provided when interactive element 113 is activated by the reader (e.g. new browser window or tab, pop-up window, etc.) and attributes defining the appearance of the visual indicator associated with interactive element 113. At block 310 a position 311 for interactive element 113 is defined. Position 311 determines the location on a particular page in digital publication 103 at which interactive element 113 may be activated by the reader (e.g. by clicking or moving the cursor to position 311, etc.). Position 311 may be set by a user drag-drop function in which an interactive element locator is moved to the desired position on the page. At block 312, the input relating to interactive element 113 which is provided in the preceding steps of method 300 is stored in memory, and processed to generate interactive element 113. Interactive element 113 may be provided on a layer of digital publication 103, such as a transparent overlay over the pages providing the static digital content (e.g. text and images). Some or all of the steps of method 300 may be repeated to generate multiple interactive elements 113. Each interactive element 113 may be provided as part of the same layer or different layers of a digital publication 103.

Other functionality associated with digital publication 103 that may be implemented in certain embodiments is a reader tag tool for permitting readers 104 to tag items of interest in digital publication 103. Readers' tagging of items may be tracked by a tracking tool 125 of digital publication platform 102 (FIG. 2) and may form part of the reading and interactive data 110B evaluated to generate reports of interest to publisher 107, the publisher 107's clients 108 and/or other businesses 112 (see FIG. 3). Items tagged by a reader 104 may be used to generate a wish list of items that may be shared by reader 104 with others.

Processor 123 may comprise a central processing unit (CPU), one or more microprocessors, one or more FPGAs, or any other suitable processing unit(s) comprising hardware and/or software configured for functioning as described herein. Processor 123 may implement the methods described herein by executing software instructions provided by software functions. Such software functions may be stored in a program memory, but this is not necessary and the software functions may be stored in other suitable memory locations within or accessible to processor 123. In some embodiments, one or more of the software functions or portions of the software functions may alternatively be implemented by suitably configured processing hardware. In other embodiments one or more logic circuits are configured to perform the methods described herein.

Digital publication platform 102 and components thereof may be configured to perform a method according to the embodiments described herein. For example, as discussed above, processor 123 may implement the methods of FIGS. 6 and 7 by executing software instructions provided by components of publication editor 127.

Particular embodiments of the invention may also be provided in the form of a program product. The program product may comprise any non-transitory medium which carries a set of computer-readable information comprising instructions which, when executed by a data processor, cause the data processor to execute a method of the invention. Program products according to the invention may be in any of a wide variety of forms. The program product may comprise, for example, physical media such as magnetic data storage media including floppy diskettes, hard disk drives, optical data storage media including CD ROMs, DVDs, electronic data storage media including ROMs, flash RAM, or the like. The computer-readable information on the program product may optionally be compressed or encrypted.

Where a component (e.g. a software module, function, platform, processor, server, interface, tool, handler, editor, device, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which perform the function in the illustrated exemplary embodiments of the invention.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. A digital publication platform for providing a digital publication, the platform comprising:
a publication server for delivering a digital publication to a reader viewing the digital publication on a reader device by interacting with a reader interface, the publication server comprising a tracker for monitoring and recording the reader's instructions to the reader interface, the instructions providing reader activity data;
a repository for storing the reader activity data;
a publication creation and management subsystem in communication with the publication server and the repository and configured to:
obtain a digital publication;
receive a request for creation of an interactive element in the digital publication from a user;
receive and confirm payment information for payment for the interactive element from the user;
create the interactive element within the digital publication;
provide the digital publication to the publication server;
receive the reader activity data from at least one of the publication server and the repository; and
determine an amount for the payment for the interactive element from the user based at least in part on the reader activity data.

2. A digital publication platform according to claim 1, wherein the publication creation and management subsystem is configured to create the interactive element by being further configured to:
identify an interactive element type;
receive interactive element data corresponding to the interactive element type; and
determine a position for the interactive element on a page of the digital publication.

3. A digital publication platform according to claim 2, wherein the publication creation and management subsystem is configured to identify the interactive element type from one of the following types:
a directory type for linking to a page within the digital publication;
a direct type for linking to an external website;
an e-commerce type for launching an e-commerce transaction;
a video type for playing a video file; and
an audio type for playing an audio file.

4. A digital publication platform according to claim 3, wherein the publication creation and management subsystem is configured to create the interactive element by further being configured to receive attributes for the interactive element, the attributes defining one or more of:
the manner in which the interactive element is activated by the reader;
the manner in which dynamic content is to be provided when the interactive element is activated by the reader; and
the appearance of a visual indicator associated with the interactive element.

5. A digital publication platform according to claim 1, wherein the tracker is configured to determine a number of times that the reader has activated the interactive element.

6. A digital publication platform according to claim 5, wherein the tracker is configured to record when the interactive element is activated by the reader.

7. A digital publication platform according to claim 1, wherein the publication server is configured to extract the reader activity data from the reader's instructions.

8. A digital publication platform according to claim 1, wherein the publication server is configured to obtain the digital publication by being further configured to:
receive a print publication in soft copy form from a publisher; and
convert the print publication to the digital publication.

9. A digital publication platform according to claim 1, comprising:
a publication repository in communication with the publication creation and management subsystem for storing content of the digital publication in searchable text-based form.

10. A computer program product comprising a computer readable medium having instructions recorded thereon for execution by a processor to create a digital publication, the instructions configured to operate the processor to:
obtain a digital publication;
receive a request for creation of an interactive element in the digital publication from a user;
receive and confirm payment information for payment of the interactive element from the user;
create the interactive element within the digital publication;
provide the digital publication to a publication server;
receive reader activity data from at least one of the publication server and a reader activity repository; and
determine an amount for the payment for the interactive element from the user based at least in part on the reader activity data.

11. A computer program product according to claim 10, wherein the instructions are configured to operate the processor to create the interactive element by further being configured to:
identify an interactive element type;
receive interactive element data corresponding to the interactive element type; and
determine a position for the interactive element on a page of the digital publication.

12. A computer program product according to claim 11, wherein the instructions are configured to operate the processor to identify the interactive element type from one of the following types:
a directory type for linking to a page within the digital publication;
a direct type for linking to an external website;
an e-commerce type for launching an e-commerce transaction;
a video type for playing a video file; and
an audio type for playing an audio file.

13. A computer program product according to claim 12, wherein the instructions are configured to operate the processor to create the interactive element by further being configured to receive attributes for the interactive element, the attributes defining one or more of:
the manner in which the interactive element is activated by the reader;
the manner in which dynamic content is to be provided when the interactive element is activated by the reader; and
the appearance of a visual indicator associated with the interactive element.

14. A computer program product according to claim 10, wherein the instructions are configured to operate the processor to obtain the digital publication by further being configured to:
receive a print publication in soft copy form from a publisher; and
convert the print publication to the digital publication.

15. A method for providing a digital publication comprising:
obtaining a digital publication;
receiving a request for creation of an interactive element in the digital publication from a user;
receiving and confirming payment information for payment for the interactive element from the user;
creating the interactive element within the digital publication;
providing the digital publication to a publication server for distribution to one or more readers;
monitoring the one or more readers' interaction with the interactive element to provide reader activity data; and
determining an amount for the payment for the interactive element based at least in part on the reader activity data.

16. A method according to claim 15, wherein creating the interactive element comprises:
identifying an interactive element type;
receiving interactive element data corresponding to the interactive element type; and
determining a position for the interactive element on a page of the digital publication.

17. A method according to claim 16, wherein the interactive element type is identified from one of the following types:
a directory type for linking to a page within the digital publication;
a direct type for linking to an external website;
an e-commerce type for launching an e-commerce transaction;
a video type for playing a video file; and
an audio type for playing an audio file.

18. A method according to claim 17, wherein creating the interactive element comprises receiving attributes for the interactive element, the attributes defining one or more of:
the manner in which the interactive element is activated by the reader;
the manner in which dynamic content is to be provided when the interactive element is activated by the reader; and
the appearance of a visual indicator associated with the interactive element.

19. A method according to claim 18, wherein monitoring the one or more readers' interaction with the interactive element comprises determining a number of times that the reader has activated the interactive element.

20. A method according to claim 19, wherein monitoring the one or more readers' interaction with the interactive element comprises recording when the interactive element is activated by the reader.
